(19) United States
(12) Patent Application Publication
(10) Pub. No.: US 2020/0087977 A1
(43) Pub. Date: Mar. 19, 2020

(54) Window Frame with a Truss Structure

(71) Applicant: CAPOFERRI SERRAMENTI S.P.A., Adrara San Martino BG (IT)

(72) Inventor: Francesco CAPOFERRI, ADRARA San MARTINO (BERGAMO) (IT)

(21) Appl. No.: 16/613,938

(22) PCT Filed: May 7, 2018
(86) PCT No.: PCT/IB2018/053148

§ 371 Date: Nov. 15, 2019

(30) Foreign Application Priority Data
May 18, 2017 (IT) 102017000053783

(51) Int. Cl. E06B 3/12; E06B 3/263

(52) U.S. Cl. CPC E06B 3/12; E06B 3/5857; E06B 3/2634

(57) ABSTRACT

The present invention relates to an elongated structure 20 for a window frame 200 suitable for supporting a panel 19 for separating an inner environment from an outer environment. The elongated structure comprises a first crosspiece 21 defining a first abutment surface 211; a second crosspiece 22 defining a second abutment surface 222, parallel to the first abutment surface, and a truss structure 23 which connects the first crosspiece to the second crosspiece. The truss structure comprises rods 230 extending from connection zones 213 of the first crosspiece to connection zones 223 of the second crosspiece; in the elongated structure according to the invention, the rods are tapered.

The present invention relates to a metal window frame, in particular for installation in buildings used as dwellings, offices, commercial establishments, and the like.

In a long-known way, openings are made in constructions to connect the two sides of the same wall. In this way, the passage of air and light, as well as of people and things, is made possible. In a likewise known manner, window frames are provided which are suitable for holding, in a fixed or movable way, panels for closing the same openings.

The window frames provided with glass panels are widely appreciated because they allow the passage of light even when they are completely closed.

Making entire walls or entire portions of a building by means of window frames and relative doors, typically with glass panels, is also known. This solution is particularly appreciated for protecting terraces, verandas, greenhouses and the like.

In the following discussion, external window frames, that is, those that separate the inside of the building from the outside, will be specifically considered. In relation to these external window frames, some specific problems must be solved.

A first problem is of mainly structural type and relates to the need for the window frame as a whole to be able to withstand stresses to which it will be subject during its service life. Stresses to be taken into consideration are of various type: the weight force of glasses, stresses which may derive from thermal dilation and the force resulting from pressure exerted by the wind. In the case of the latter, the resultant force may be either positive (that is, deriving from a pressure acting from the outside, perpendicularly to the glass surface) or, more rarely, negative (that is, deriving from a depression on the glass surface). Between the two load conditions, the heaviest is the first and the window frame must be designed based on it, in order to guarantee the necessary structural resistance.

Another problem, more perceived by the end users, is the efficient insulation of the indoor space from the outer environment, both thermal and acoustic. As far as the glass panel is concerned, insulation improvement is obtained by insulating glasses (with double or triple glass panels) and/or athermal glasses and/or screened glasses.

As for the window frame, being placed by definition along the actual discontinuity between indoor and outdoor space, insulation is more discreet. At this point, two distinct problems arise: one is the need to limit as much as possible air leakage trough the gap between the fixed parts and the movable parts of the window frame, and the other is the need to limit heat conduction through the same window frame.

Specific solutions have been developed for each type of window frame in order to progressively improve insulation. As for the first problem, the use of seals is known. Typically, to be effective, the seals must be compressed or deformed by the window frame when it reaches the closed position.

As regards the problem of limiting the thermal conductivity of the window frame itself, there are a number of solutions that will be examined below.

A first type of window frames that solves this problem is that of the window frames entirely made of a material with low thermal conductivity, typically PVC (polyvinylchloride) or wood. However, unlike wood, PVC is usually not able to perform the required structural functions and must therefore be reinforced with metal profiles set up in appropriate cavities. Wood, on the other hand, besides having a low thermal conductivity, also has good mechanical features.

A second type of window frames that solves this problem is that of the window frames having a metal structure and with the so-called thermal break. According to this solution, the metal structure of the window frame is not continuous but it is interrupted by an insulating diaphragm. In other words, the portion visible from inside the dwelling is separated from the portion visible from the outside of the dwelling. Separation is obtained by means of a diaphragm made of a material with low thermal conductivity. Typically, the metal structure of the window frame is made of aluminium profiles, while the insulating diaphragm is made of polymer. In this way it is possible to avoid a large part of heat transmission through the window frame itself. Note how the interposition of a diaphragm made of polymer interrupts the structural continuity of the window frame by introducing a point of weakness. The overall design of the window frame must therefore take into account the polymer diaphragm.

A further type of window frame provides that a portion, usually the one intended to be turned inward, is made of wood, while another portion, usually the one intended to be turned towards the outside, is made of aluminium. This solution, in the face of a certain constructive complexity, allows to exploit at the same time the greater pleasantness of the wood and the greater resistance of aluminium to atmospheric agents.

These solutions, although widely appreciated, are not without drawbacks. In fact, the window frames of the typologies presented above must have relatively wide cross-sections, which therefore reduce the extension of the glass surface.

In fact, another particularly felt need is to reduce as much as possible the cross-section of each element of the window frame, so as to obtain the maximum glass surface and the lower thermal conductivity, with the same opening gap.

The intrinsic mechanical features of wood and aluminium are such as to require a rather large resistant section to be able to effectively counteract the design stresses. This disadvantage is found in window frames made with only one of the two materials (either wood or aluminium), as well as in those made with the combination of both materials (both wood and aluminium).

As for the mechanical features of PVC, they are still inferior, hence the combined necessity of a wide resistant section and an internal reinforcement usually made of steel. The need to provide the reinforcement naturally implies a complication of the manufacturing of the window frame, as well as an increase in the weight of the same.

Therefore, the object of the present invention is to overcome the drawbacks of the known art highlighted above.

In particular, a task of the present invention is that of making available a window frame structure that has at the same time a reduced cross-section, excellent thermal insulation features and the mechanical features needed to withstand the design loads.

Furthermore, a task of the present invention is that of making available a window frame and a window made with the window frame structure having the above-described features.

This object and tasks are achieved by means of a window frame structure according with claim 1.

To better understand the invention and appreciate its advantages, some of its exemplifying and non-limiting embodiments are described below with reference to the accompanying drawings, wherein:

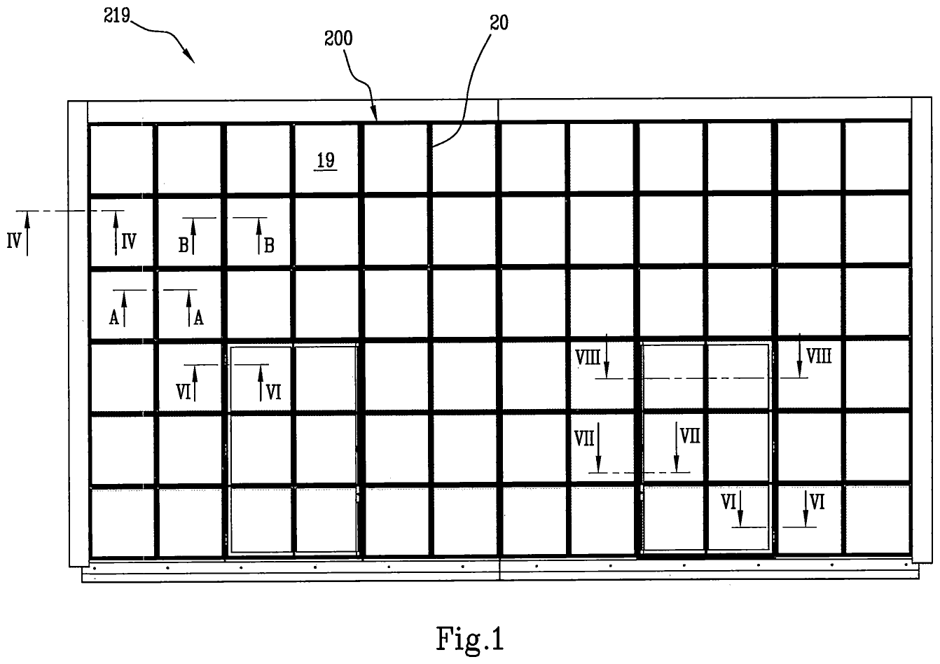

FIG. 1 is a perspective view of a window comprising a window frame according to the invention;

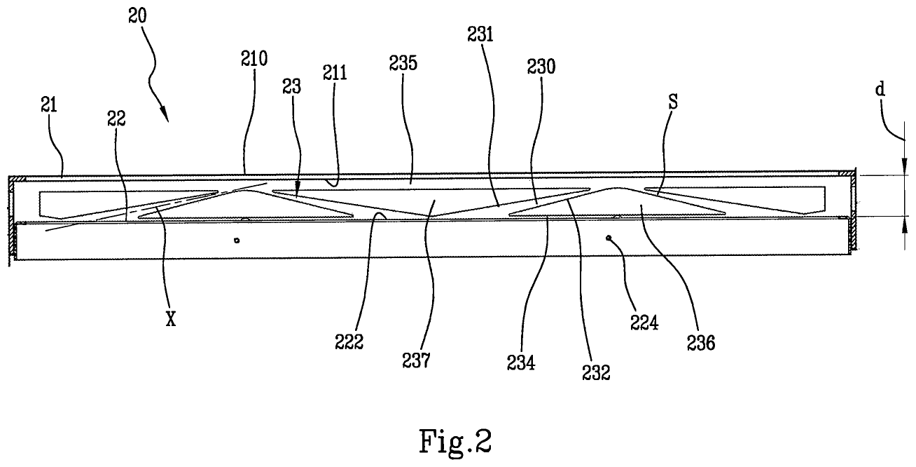

FIG. 2 shows a side view of an elongated structure of a window frame according to the invention;

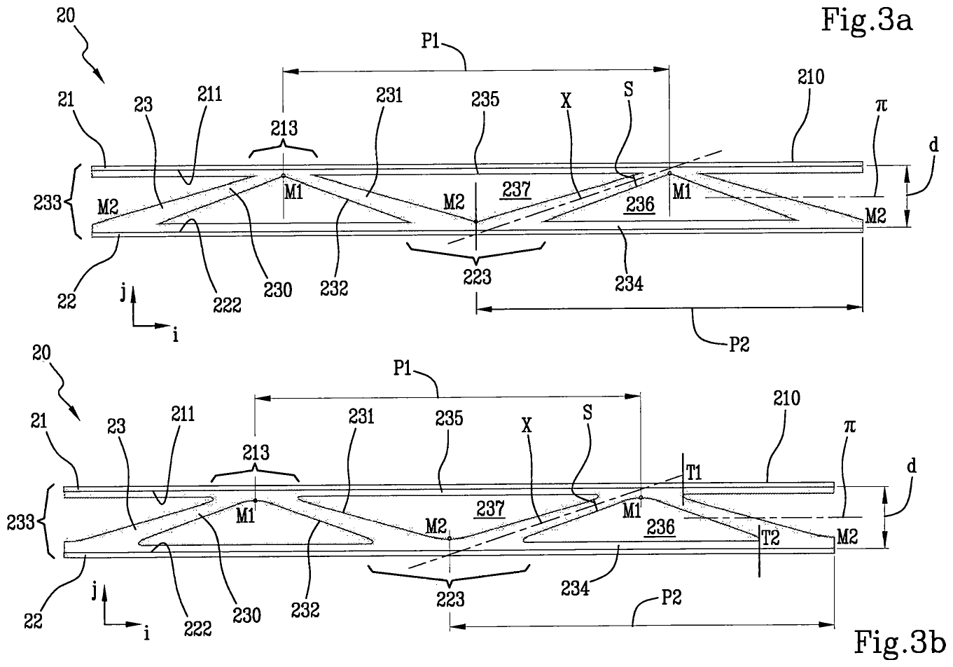

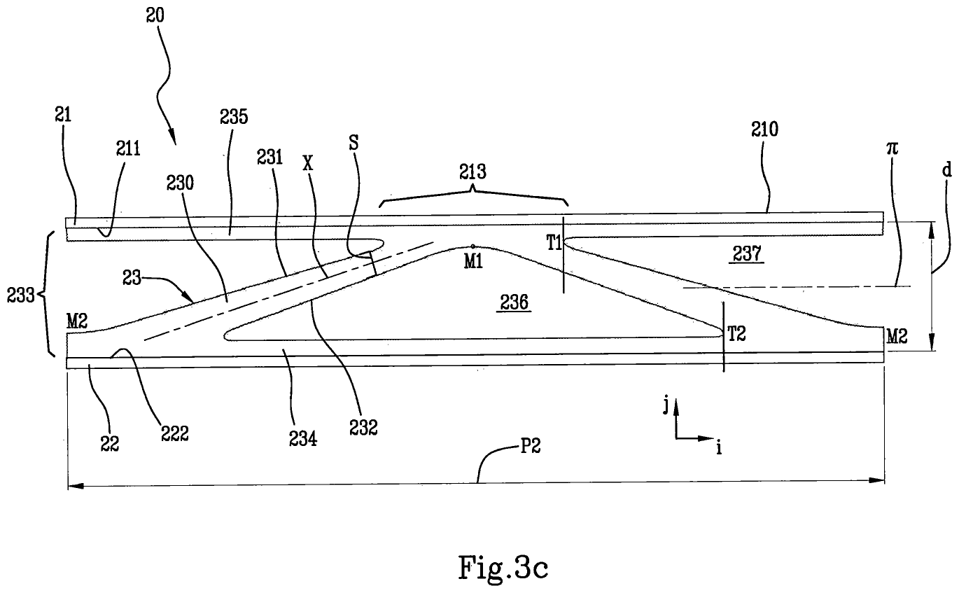

FIG. 3.a schematically represents a view similar to that of FIG. 2;

FIG. 3.b schematically represents another view similar to that of FIG. 2;

FIG. 3.c represents an enlarged view of a detail of FIG. 3.b;

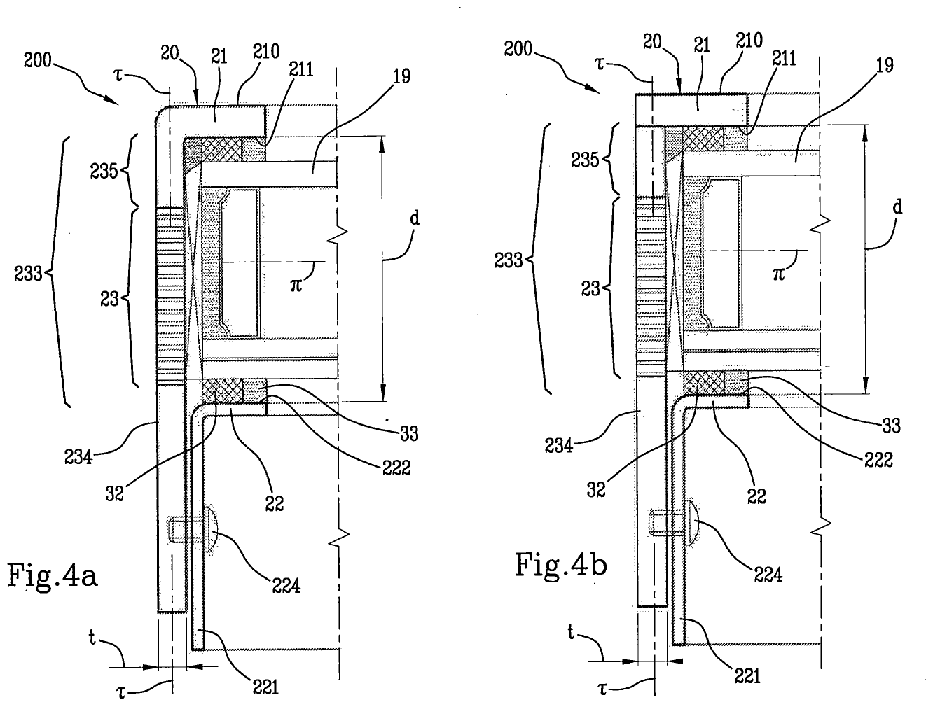

FIG. 4.a represents a possible section of the window according to the invention, along the line IV-IV of FIG. 1;

FIG. 4.b represents another possible section of the window according to the invention, along the line IV-IV of FIG. 1;

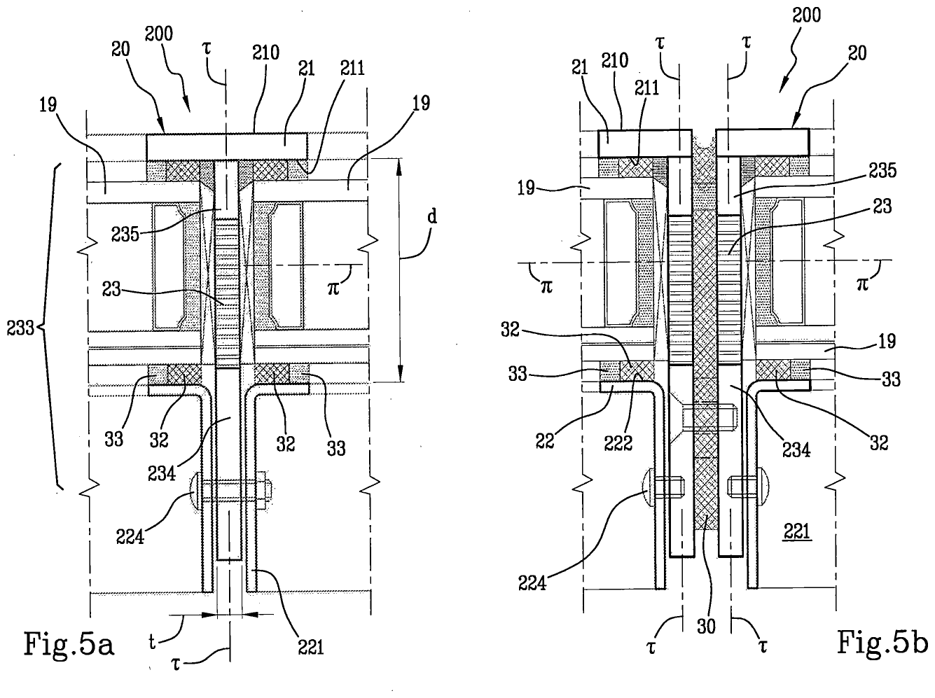

FIG. 5.a represents a possible section of the window according to the invention, along the line A-A of FIG. 1;

FIG. 5.b represents a possible section of the window according to the invention, along the line B-B of FIG. 1;

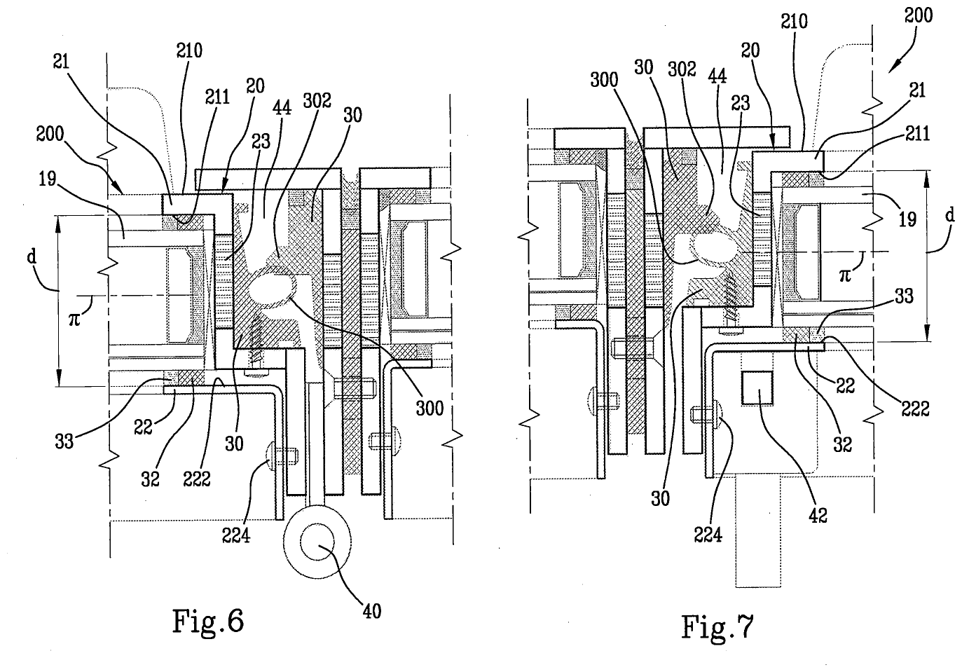

FIG. 6 represents a possible section of the window according to the invention, along the line VI-VI of FIG. 1;

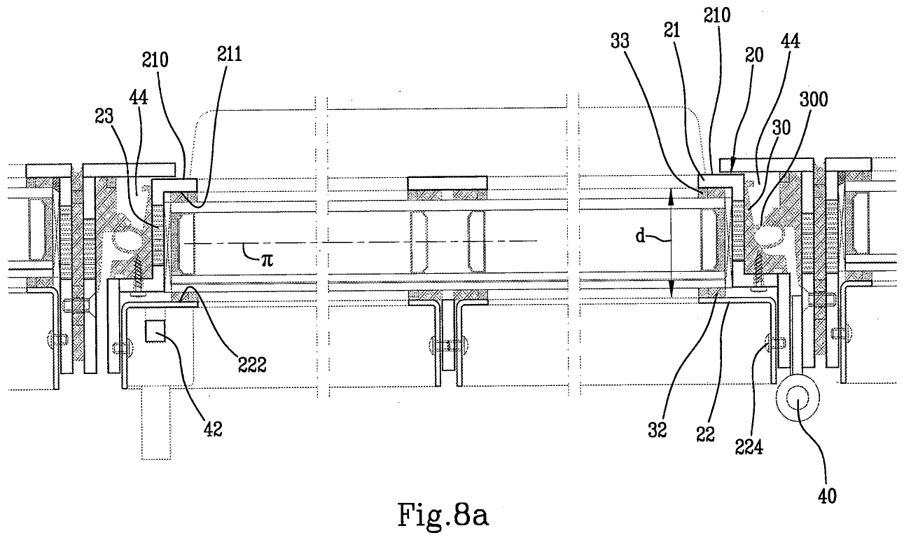

FIG. 7 represents a possible section of the window according to the invention, along the line VII-VII of FIG. 1;

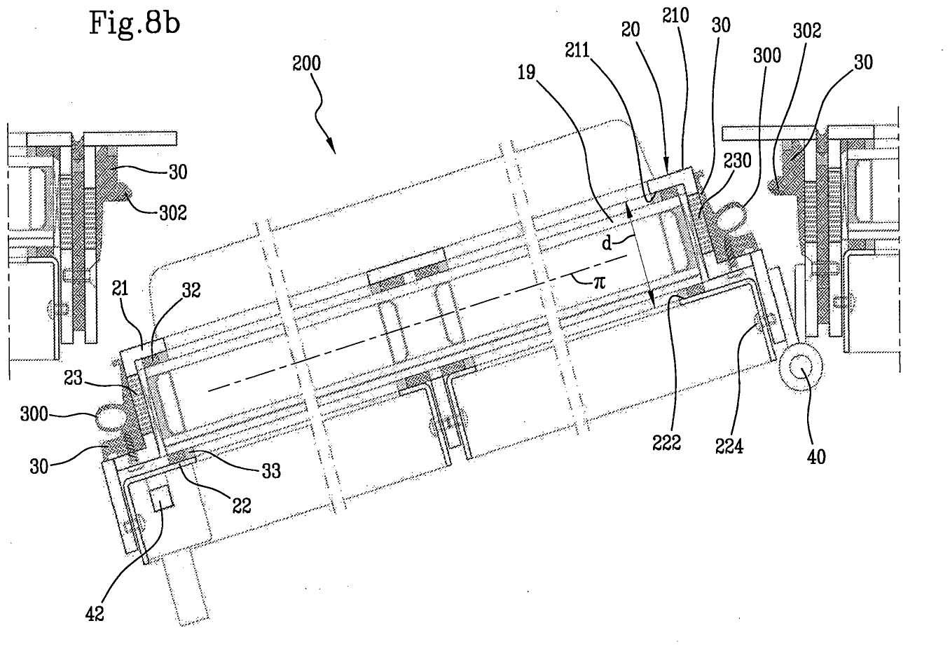

FIG. 8.a represents a possible section of the window according to the invention, along the line VIII-VIII of FIG. 1, in a closed configuration;

FIG. 8.b represents the section of FIG. 8.a, in an open configuration;

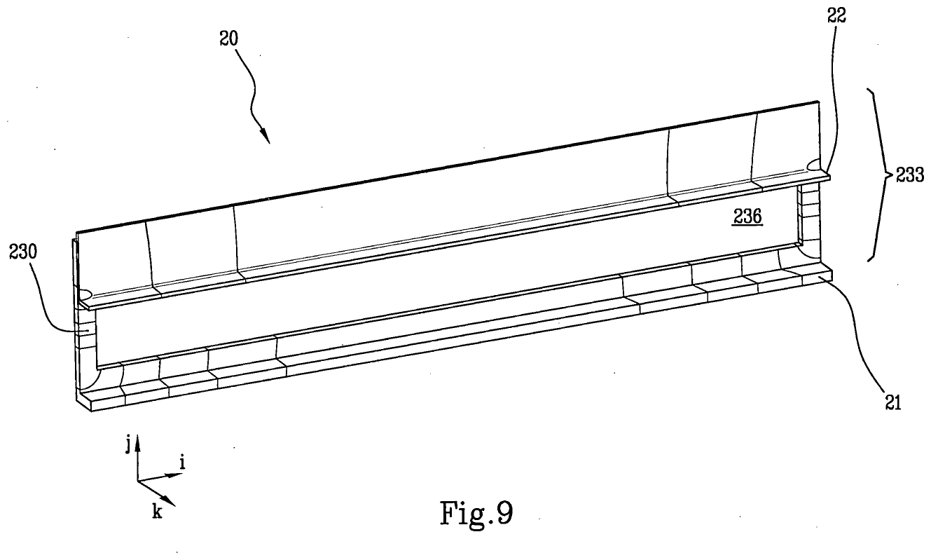

FIG. 9 schematically represents a first study configuration for an elongated structure;

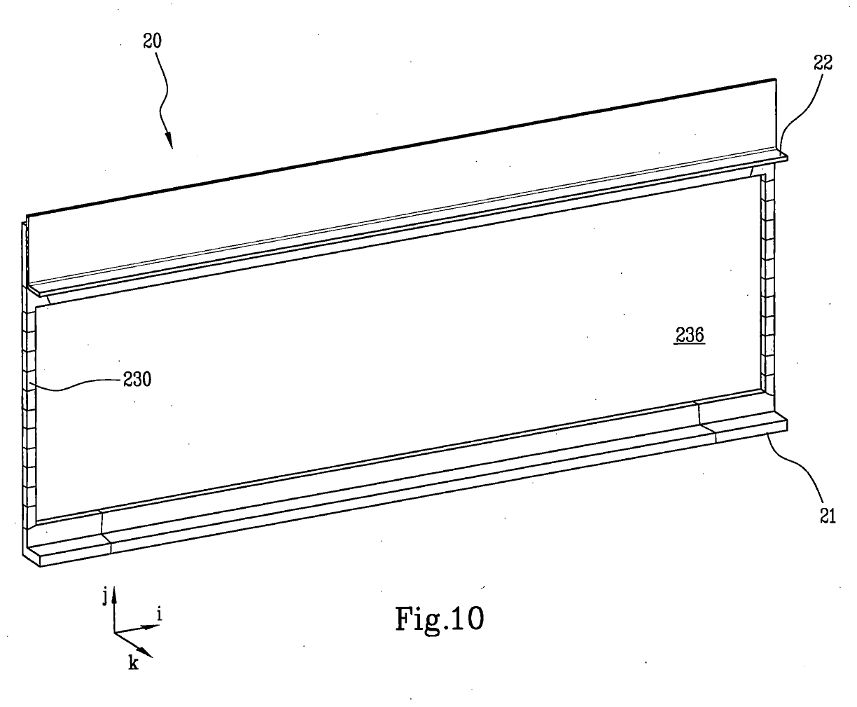

FIG. 10 schematically represents a second study configuration for an elongated structure;

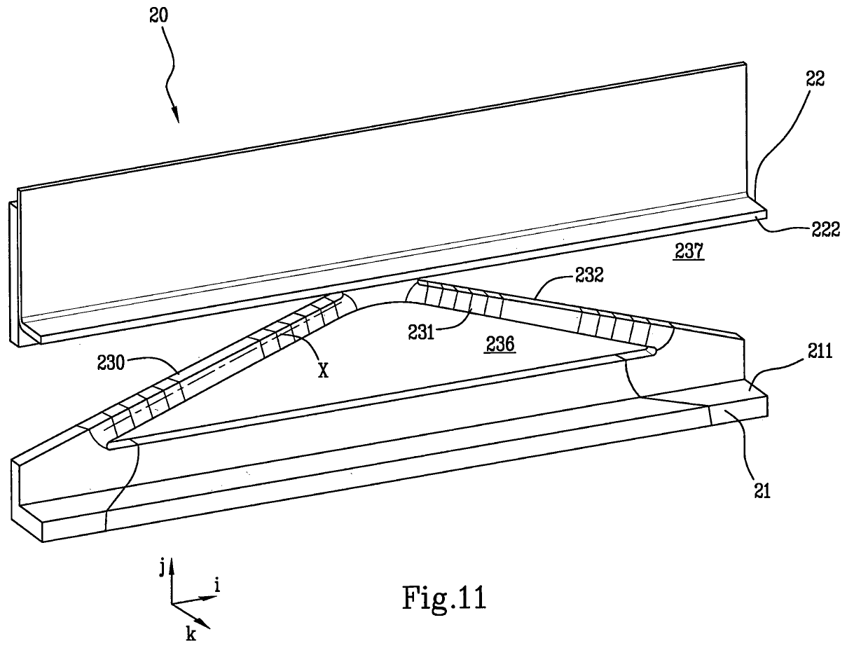

FIG. 11 schematically represents a third study configuration for an elongated structure;

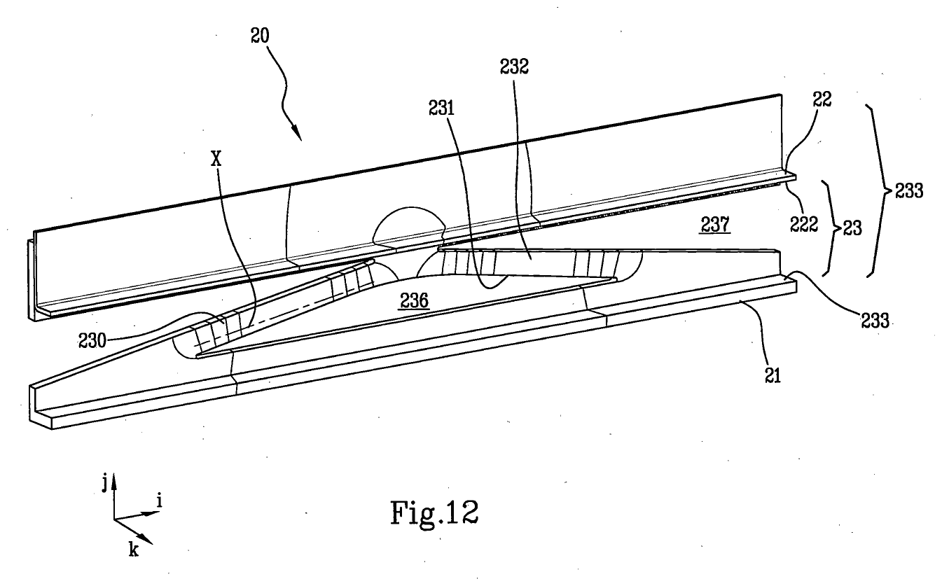

FIG. 12 schematically represents a fourth study configuration for an elongated structure;

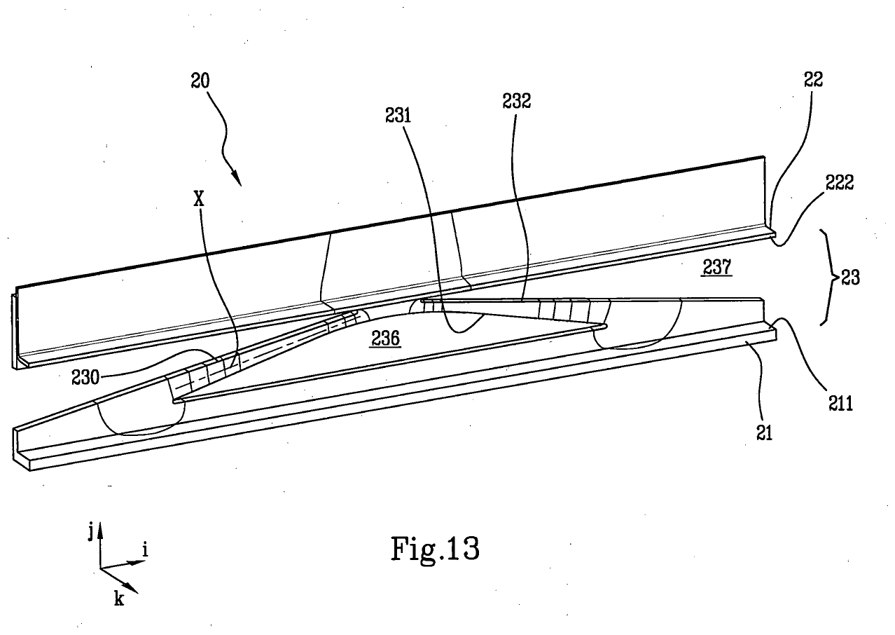

FIG. 13 schematically represents a fifth configuration of an elongated structure according to the invention;

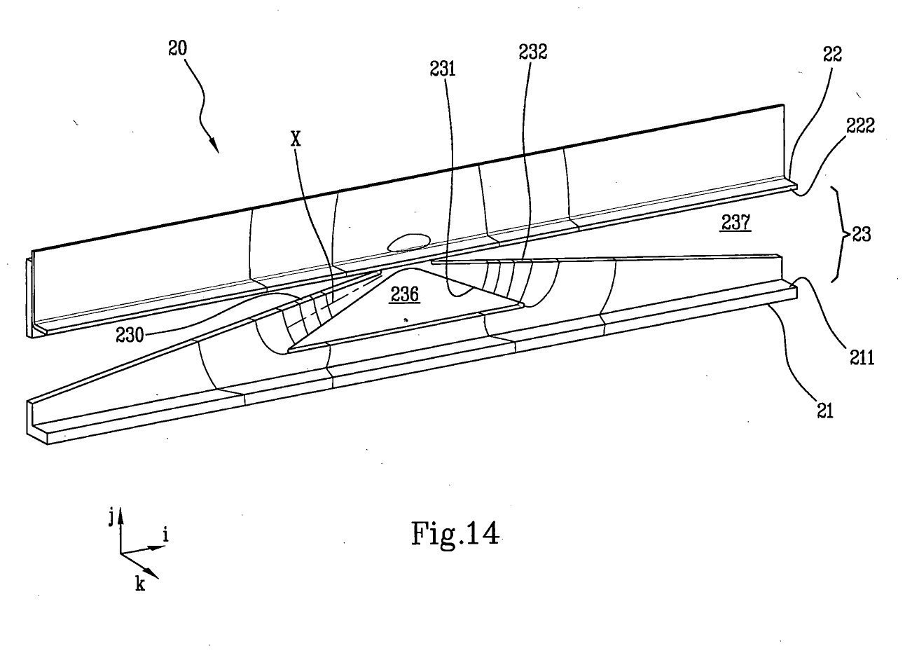

FIG. 14 schematically represents a sixth configuration of an elongated structure according to the invention;

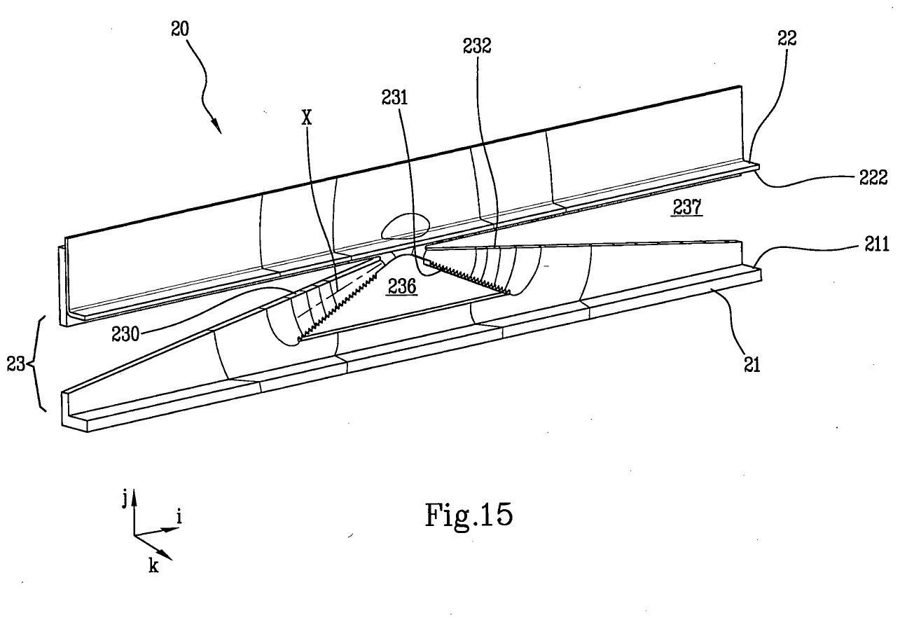

FIG. 15 schematically represents a seventh configuration of an elongated structure according to the invention; and

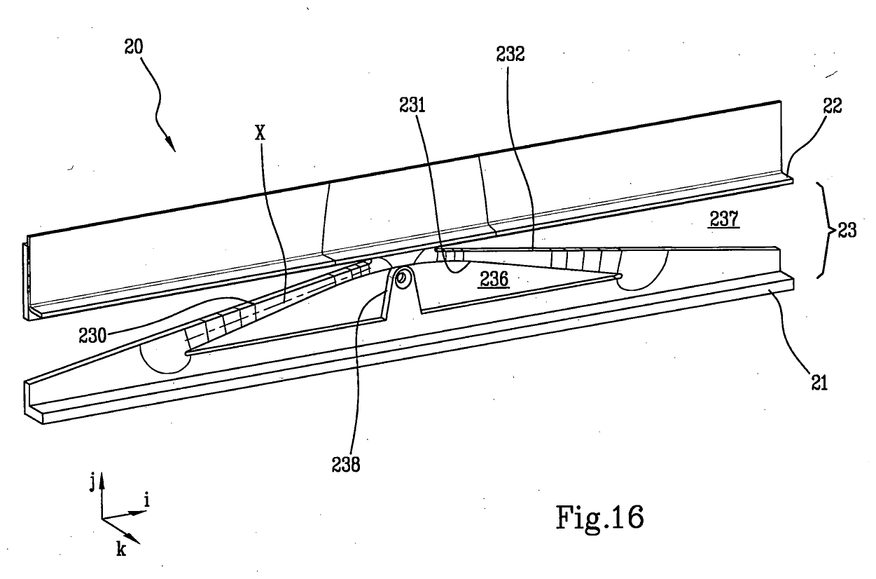

FIG. 16 schematically represents an eighth configuration of an elongated structure according to the invention.

In the context of the present discussion, some terminological conventions have been adopted in order to make reading easier and smoother. These terminological conventions are clarified below with reference to the attached figures.

The terms ‘internal’ and ‘external’ refer to a correctly fitted window frame to divide the interior from the outside of a building. Naturally, the window frame according to the invention could also be assembled completely inside a building, for example to separate two internal spaces, or completely outside. In these cases, however, some of the technical features of the window frame would be superfluous.

The term ‘elongated structure’ indicates the basic element of the window frame, having a prevalent development along an axis. The elongated structure is intended to be connected to other elongated structures.

The term ‘window frame’ means a plurality of elongated structures connected to each other, so as to support a panel.

The term ‘window’ indicates a window frame provided with the relative panel.

The invention relates, first of all, to an elongated structure 20 for a window frame 200 suitable for supporting a panel 19 for separating an inner environment from an outer environment. The elongated structure 20 comprises:
a first crosspiece 21 defining a first abutment surface 211;
a second crosspiece 22 defining a second abutment surface 222, parallel to the first abutment surface 211; and
a truss structure 23 connecting the first crosspiece 21 and the second crosspiece 22.

In the elongated structure 20, the truss structure 23 comprises rods 230 extending from connection zones 213 of the first crosspiece 21 to connection zones 223 of the second crosspiece 22.

Moreover, in the elongated structure 20 according to the invention the rods 230 are tapered.

In the elongated structure 20 the first abutment surface 211 is spaced from the second abutment surface 222 by a distance d; preferably the distance d is comprised between 25 mm and 82 mm.

In the elongated structure 20, each rod 230 comprises an outer edge 231, facing the first crosspiece 21, and an inner edge 232, facing the second crosspiece 22; preferably in each rod 230, the shorter one among the outer edge 231 and the inner edge 232 is at least 100 mm long.

In the elongated structure 20:
the connection zones 213 of the first crosspiece 21 are spaced the one from the other by a pitch p1;
the connection zones 223 of the second crosspiece 22 are spaced the one from the other by a pitch p2; and
   preferably at least one of p1 and p2 is greater than 350 mm.

In the elongated structure 20 each rod 230 defines a minimum cross section; preferably the minimum cross section has an extension s such that t≤s≤2t.

As the skilled person can well understand, part of the accessory technical features of the elongated structure 20 of the window frame 200 are expressed through some parameters: the distance d between the abutment surfaces 211 and 222; the length of the shortest between the outer edge 231 and the inner edge 232 of each rod 230; the pitches p1 and p2 between the connection zones 213 and 223 of the crosspieces 21 and 22; and the extension s of the minimum cross section of each rod 230. Further details regarding these parameters will be shown below.

Advantageously, the first abutment surface 211 defined by the first crosspiece 21 and the second abutment surface 222 defined by the second crosspiece 22 develop in parallel to a plane π. Equally advantageously, the truss structure 23 extends mainly in a plane τ, perpendicular to the plane π. The thickness t of the truss structure 23 is measured perpendicular to the plane τ.

Preferably the elongated structure 20 is made starting from a metal laminate, for example from a stainless steel, iron, brass, bronze, aluminium or copper laminate. The laminate preferably has a thickness t comprised between 3 mm and 7 mm, more preferably between 4 mm and 6 mm, perpendicular to the plane τ (see in particular FIGS. 4.a, 4.b and 5.a). These features of the laminate (in terms of measurements and material) allow the elongated structure 20 and the window frame 200 to withstand the design stresses to which they are expected to be subjected during their working life.

In accordance with the embodiments shown in the attached figures, the truss structure 23 is part of a web 233 which comprises, in addition to the truss structure 23, an inner rib 234 and an outer rib 235. The inner rib 234 and the outer rib 235 are preferably continuous, in order to simplify joining with the crosspieces 21 and 22. Also the whole web 233, like the truss structure 23, extends mainly in the plane τ. Preferably, in the truss structure 23, openings 236 and 237 are included between the rods 230.

Preferably the web 233 is obtained starting from a flat laminate, inside which, by removal of material, the openings 236 and 237 adjacent to one another are obtained. The portions of material that remain between two openings 236 and 237 adjacent to each other constitute the rods 230 of the truss structure 23.

The removal of material to form openings 236 and 237 can be advantageously performed by laser cutting. This technology allows a wide freedom in the choice of the shape of the openings 236 and 237 and, consequently, of the shape of the rods 230. Alternatively, the removal of material to form openings 236 and 237 can be performed by other technologies known by the skilled person.

As the person may well understand, it is advantageous to shape the openings 236 and 237 and the rods 230 so as to gently connect the direction changes, typically between the rods 230 and the ribs 234 and 235 (see FIG. 3. for this purpose). In this way it is possible to avoid acute notches (see FIG. 3.a) which, as is known, locally determine an amplification of the stresses and lead more easily to the onset of cracks and fractures as a result of which the whole structure can undergo a failure.

Preferably, therefore, a first flat laminate is worked to obtain the truss structure 23 and the two ribs 234 and 235. Then a second laminate, also preferably flat, is joined to the outer rib 235, so as to form the first crosspiece 21. If the elongated structure 20 is designed to support two panels 19, one for each side, the web 233 and the first crosspiece 21 can be joined so as to form as a whole a structure with a T-shaped cross-section (see, for example, FIG. 5.a). If, on the other hand, the elongated structure 20 is designed to support a single panel 19, the web 233 and the first crosspiece 21 can be joined so as to form as a whole a structure with an L-shaped cross-section.

The union between the web 233 and the first crosspiece 21 is preferably obtained by welding, even more preferably by laser welding. Advantageously, the first crosspiece 21, in addition to the first abutment surface 211, also defines an external finishing surface 210, which potentially remains visible next to the panel 19. The union between the web 233 and the first crosspiece 21 by welding has the advantage of obtaining that the outer finishing surface 210 is defined by two identical corners and which can potentially be sharp corners (see for example FIG. 4.b).

As an alternative to welding, the union between the web 233 and the first crosspiece 21 can be obtained by bolting (not shown in the attached figures). In this case, the thickness t of the web 233 must be such as to allow the holes which receive the bolt stems to be formed therein.

In accordance with other embodiments, a single flat laminate can be machined by removing material, so as to form the truss structure 23 and then folded so as to form the first crosspiece 21 as well. In this case, the web 233 and the first crosspiece 21 necessarily form a structure with an L-shaped cross-section, designed to support a single panel 19 (see, for example, FIG. 4.a). This embodiment has the advantage of replacing the welding step with a simpler profile bending step.

Furthermore, a single profile with an L-shaped cross-section can be machined by removing material, so as to simultaneously form the truss structure 23 on a wing and the first crosspiece 21 on the other wing. Also in this case, the elongated structure 20 is designed to support a single panel 19. This embodiment (not shown) has the advantage of completely avoiding both the welding step and the profile bending step.

FIG. 5.b shows another solution, alternative to that of FIG. 5.a, to support two panels 19, one for each side of the elongated structure 20. In this case, two elongated structures 20 with an L-shaped cross-section are brought together. Specifically in FIG. 5.b, the elongated structure 20 shown on the right is identical to that of FIG. 4.b, while the one represented on the left is symmetrical with respect to a plane parallel to plane τ.

As the skilled person can easily see, in the elongated structure 20 of FIG. 5.b a seal 30 is also included. The seal 30 extends between the two webs 233, parallel to the plane τ, so as to cover laterally the openings 236 and 237 which are located between the rods 230 of the truss structure 23. As can be seen also in FIG. 5.a, a similar side cover of the openings 236 and 237 is obtained by the edges of panels 19. In fact, in accordance with what has been determined by the applicant during the conducted experimental and simulation campaigns, for the purposes of thermal insulation, it is important that the openings 236 and 237 are insulated from the surrounding environment. In this regard, it should be noted here that, again for thermal insulation purposes, no specific advantages have been obtained from the introduction of insulating materials in the openings 236 and 237. From this point of view, therefore, it is considered convenient to avoid this further processing and to close laterally the openings 236 and 237 so as to maintain still air inside them isolated from the outside.

As an alternative to that described above, it is certainly possible to obtain the truss structure 23 by cutting the rods 230 from a flat metal laminate and welding them one by one directly to the first crosspiece 21 and to the second crosspiece 22.

In accordance with the illustrated embodiments, the rods 230 define their own longitudinal axis x. In this case, the minimum cross section s is usually considered perpendicular to the x axis.

As can be seen from FIGS. 4 and 5, the web 233 extends into the plane τ well beyond the distance d. In other words, the web 233 extends from the outside to the inside well beyond the thickness of the panel 19. This makes it possible to apply to the web 233 a profile 221 with an L-shaped cross section and adapted to define the second crosspiece 22.

Preferably, the second crosspiece 22 can be applied to the web 233 subsequently to the other steps of making the elongated structure 20, even more preferably it can be applied in a removable manner. The second crosspiece 22 can be applied to the web 233 by one or more fasteners 224, for example bolts.

In accordance with the embodiments shown in the sections of FIGS. 4 to 8, spacers 32 are interposed between the abutment surfaces 211 and 222 and the panel 19. Preferably, a first spacer 32 is arranged between the outer surface of the panel 19 and the first abutment surface 211 of the window frame 200. In addition or alternatively, a second spacer 32 is preferably provided between the inner surface of the panel 19 and the second abutment surface 222 of the window frame 200. The spacers 32 are designed to prevent direct contact between the metal of the abutment surfaces 211 and 222 and the panel 19, especially when the latter is made of glass. The thickness of the spacers 32 is usually between 2.5 mm and 6 mm, preferably equal to 5 mm. This thickness causes the distance d between the abutment surfaces 211 and 222 of the window frame 200 to be greater than the thickness of the panel 19 which is usually between 20 mm and 70 mm.

As can be seen in FIGS. 4 and 5, each spacer 32 can also be flanked by a sealing cord 33, for example made of silicone.

As already mentioned above, part of the technical features of the elongated structure 20 are expressed through some parameters: the distance d between the abutment surfaces 211 and 222; the length of the shortest between the outer edge 231 and the inner edge 232 of each rod 230; the pitches p1 and p2 between the connection zones 213 and 223 of the crosspieces 21 and 22; and the extension s of the minimum cross section of each rod 230. These parameters were defined by the applicant through a series of experimental investigations and numerical simulations, aimed at studying the behaviour of the elongated structure 20 from a structural and a thermal point of view.

With reference to FIGS. 3.a, 3.b and 3.c, some criteria are given to obtain a correct measurement of the considered parameters. In this discussion, reference will be made to the directions of the vectors i and j represented in FIG. 3. A third vector k outgoing from the drawing plane completes a right-hand set of three.

In the case shown in FIG. 3.a, the measurement of the parameters considered here can be obtained in a rather intuitive way. In fact, in this specific case, the openings 236 and 237 have a triangular shape in the proper sense and therefore it is intuitive to consider the vertices of the triangles as ends of the edges. Thus, the length of the outer edge 231 and the inner edge 232 of each rod 230 can easily be measured from the vertices representing the ends. With respect to pitches p1 and p2, they can be measured between the midpoints M1 and M2 of the respective connection zones 213 and 223 of the crosspieces 21 and 22. Incidentally, because of this convention, the pitches p1 and p2 are usually identical. As can be seen, the midpoint of a connection zone coincides with the vertex of the corresponding aperture. In particular, the midpoint M1 of the connection zone 213 coincides with the vertex of the opening 236, while the midpoint M2 of the connection zone 223 coincides with the vertex of the opening 237.

On the contrary, in the case shown in FIGS. 3.b and 3.c, the measurement of the considered parameters may be less intuitive. In fact, in this specific case the openings 236 and 237 do not have a triangular shape in the proper sense, but they have the shape of a triangle with rounded vertices. In this case, therefore, to measure the length of each edge, it is necessary to identify a univocal convention to identify the ends. Each edge has an end defined by the midpoint of a crosspiece connection zone. In particular, the inner end of the outer edge 231 is the midpoint M2 of the connection zone 223. Similarly, the outer end of the inner edge 232 is the midpoint M1 of the connection zone 213. The other extremes are identified by the points of tangency T1 and T2 between the curve that delimits the openings 236 and 237 and a straight line parallel to the vector j. In particular, the outer end of the outer edge 231 is the tangency point T1 between the curve which defines the opening 237 and a straight line parallel to the vector j. Likewise, the inner end of the inner edge 232 is the tangency point T2 between the curve which defines the opening 236 and a straight line parallel to the vector j. By the way, it should be noted that this convention can be applied even if the openings 236 and 237 have different shapes. Finally, analogously to the case of FIG. 3.a, pitches p1 and p2 can be measured between the midpoints M1 and M2 of the respective connection zones 213 and 223 of the crosspieces 21 and 22.

As far as thermal performances are concerned, the simulations performed by the applicant have assumed a condition that can be defined as winter, in which the inner part of the window frame is exposed to a temperature of 20° C. and the external part is exposed to a temperature of 0° C. It is of course possible to assume different conditions, for example summer, but the results of the simulation would not change.

In accordance with the hypothesis of the simulation, panels 19 with very low thermal conductivity are mounted on the window frame 200, so that heat transmission occurs only through the material of the window frame 200, essentially along the plane τ. According to this hypothesis, therefore, the thermal performance of the window frame 200 can be quantified in relation to ΔT, i.e. the maximum measurable temperature difference between the inside and the outside of the elongated structure 20. It is considered that an acceptable ΔT in these conditions must be at least 15.5° C. ΔTs lower than 15.5° C. indicate excessive heat transmission from the inside to the outside, a situation wherein the heat itself is dispersed in the external environment, reducing comfort inside.

All the various configurations considered below for the elongated structure 20 are made starting from a flat steel laminate having a thickness t of 5 mm, measured in a direction k.

The simulations relating to some of the assumed configurations are not even reported because they are too far from the required efficiency. For example, a window frame comprising a continuous web, without any truss structure, is understandably free of any thermal break. In this case, the thermal bridge between the inside and the outside is far too large and, consequently, ΔT is excessively low.

The results of the most interesting simulations are instead shown in FIGS. 9 to 16, where on each elongated structure 20 the temperature zones are shown with the isothermal lines method.

In the description of the configurations shown in FIGS. 9 to 16, reference will still be made to the directions of the i-j-k vectors of the represented set of three.

A first configuration for which the results of the simulation are reported here is that of FIG. 9. In this case the idea of inserting a thermal break between inside and outside was carried out simply by the opening of openings 236 in the web 233. The openings 236 extend for 410 mm in the direction i and for 30 mm in the direction j. The measurement of 30 mm in the direction j is dictated by the need to maintain the openings 236 included in the typical thickness of a panel 19. In this case the pitches p1 and p2 between the connection zones 213 and 223 of the crosspieces 21 and 22 coincide and are equal to 420 mm (in the direction i). The result is that the structural and thermal continuity between inside and outside is guaranteed by some short rods 230, substantially perpendicular to the plane π of the abutment surfaces 211 and 222 (also identifiable as the plane ik). In this case the rods are 30 mm long (in the direction j) and have a constant width of 10 mm (in the direction i). Consequently, the minimum cross section of the rod 230 has an extension s equal to 2t. For this configuration, the simulated ΔT is 12.297° C., and is therefore excessively low.

A second configuration for which the results of the simulation are reported here is that of FIG. 10. In this case, the basic idea of the thermal break of FIG. 9 has been exasperated. In fact, the performances of the configuration of FIG. 9, although insufficient, have suggested that the use of openings 236 may be useful, but that at the same time the distance of 30 mm in direction j is excessively short. For the sole purpose of verifying this assumption, hypothesized herein are 415 mm-long (in direction i) and 105 mm-wide (in direction j) openings 236. The result is that the structural and thermal continuity between inside and outside is guaranteed by some rods 230, substantially perpendicular to the plane π of the abutment surfaces. In this case, the rods are 105 mm long (in direction j) and have a constant width of 5 mm (in direction i). Consequently, the minimum cross section of the rod 230 has an extension s equal to t. Pitches p1 and p2 are still identical and equal to 420 mm. For this configuration the simulated ΔT is 16.636° C., and is therefore excellent. Naturally, such a configuration cannot have any practical confirmation, for at least two reasons, both immediately understandable by the skilled person. First of all, it is not possible for a panel 19 to cover with its own thickness a length of 105 mm in the direction j and this nullifies some of the hypotheses made at the beginning for the simulation. The consequence would be that the openings 236 and the cold parts of the window frame would enter markedly inside the building. In addition, the rods 230, 105 mm long and 5 mm wide, are far too thin to guarantee the necessary structural features.

A third configuration for which the results of the simulation are reported herein is that of FIG. 11. In this case we have tried to report the basic idea of the thermal break of FIG. 10, that is the long and thin rods 230, within a thickness of 30 mm, like that of FIG. 9. The solution explored here has been to incline the rods 230 each of which now has its own x axis. Because of their inclination, the rods 230 have here an outer edge 231 and an inner edge 232, having different lengths. Furthermore, in this configuration, the connection zones of the crosspieces are defined. In the specific case, the extension s of the minimum cross section is equal to t (5 mm) and the shorter edge of the rod 230 (i.e. the outer one) is 83 mm long. Finally, to improve the structural features, the pitch p2 between the connection zones 223 of the crosspiece 22 has been reduced to 210 mm (in direction i). For this configuration, the simulated ΔT is 13.386° C., and is therefore too low, but some insights seem to be promising, in particular that of tilting the rods 230.

A fourth configuration for which the results of the simulation are reported herein is that of FIG. 12 and directly derives from that of FIG. 11. In this case the rods 230 are more inclined, so as to be longer while remaining within the thickness of 30 mm measured in the direction j. The extension s of the minimum cross section is equal to 2t (10 mm) and its shorter edge of the rod 230 (i.e. the outer one) is 120 mm long. Finally, to improve the thermal features, the pitch p2 has been increased to 420 mm (in direction i). For this configuration the simulated ΔT is of 15.507° C., and is therefore acceptable, but it is assumed that some further improvement can be achieved.

A fifth configuration for which the results of the simulation are reported herein is that of FIG. 13 and directly derives from that of FIG. 12. In this case the rods 230 are tapered, so that the extension s of the minimum cross section is reduced to t (5 mm). Another effect of the tapering is that the shorter edge of the rod 230 (i.e. the outer one) is slightly longer: 124 mm. The pitch p2 was kept at 420 mm (in direction i). For this configuration the simulated ΔT is 16.588° C., and is therefore excellent. It should be noted that the tapering of the rods 230 does not imply a significant deterioration of the structural features. Therefore, this configuration is considered optimal. Despite this, it is considered appropriate to try some further configuration.

A sixth configuration for which the simulation results are reported here is that of FIG. 14, and derives directly from that of FIG. 13. In this case, in fact, the rods 230 are tapered, so that the extension s of the minimum cross section is kept equal to t (5 mm) and so that the opposite end of the single rod is decidedly wider to investigate the possibility to improve the mechanical features. The tapering thus accentuated causes the shorter edge of the rod 230 (i.e. the outer one) to be considerably shortened: 72 mm. The pitch between the connection zones of the crosspieces was maintained at 420 mm (in direction i). For this configuration the simulated ΔT drops to 14.255° C., and is therefore excessively low.

A seventh configuration for which the simulation results are reported here is that of FIG. 15, and derives directly from that of FIG. 14. In this case too, in fact, the rods 230 are strongly tapered, and essentially have the same shape as those of FIG. 14. The difference between the two solutions is the development of the shorter edge of the rod 230 (i.e. the outer one). In fact, in the configuration of FIG. 14, the outer edge 231 of the rod 230 is rectilinear and therefore has a development equal to the geometric length: 72 mm. On the contrary, in the configuration of FIG. 15, the outer edge 231 of the rod 230 is undulated and therefore has a decidedly greater development than the geometric length: 124 mm. This configuration has been developed to increase the surface of the outer edge 231 and to make it equal to that of the optimal case of FIG. 13. This was done to verify whether the heat dispersion in the still air within the opening 236 adjacent the outer edge 231 could help. However, for this configuration the simulated ΔT drops further to 14.167° C., and therefore the configuration is not acceptable.

Finally, an eighth configuration for which the simulation results are reported here is that of FIG. 16, and derives directly from that of FIG. 13. The configuration of FIG. 13 is maintained unchanged, except for the addition of a strut 238 which extends in a direction j from the outer side towards the inner side of the elongated structure 20, but remains disconnected by a few tenths of a millimetre. The presence of the strut 238 is advantageous from a structural point of view. In fact, as initially stated, one of the most severe design conditions is that in which the wind applies a pressure perpendicular to the surface of the panel 19. In this condition, following a minimum deformation of the elongated structure 20, the strut 238 comes into contact with the inner rib 234, from which it is separated by a few tenths of a millimetre. In this condition, therefore, the strut 238 works by compression, actively cooperating in transferring the wind load. Furthermore, in accordance with the configuration of FIG. 16, the strut comprises an assembly hole which allows structurally connecting the window frame 20 to a side structure. For this configuration the simulated ΔT is maintained at 16.261° C., and is therefore optimal.

The features of the different configurations considered above are briefly shown in the table below.

| | t | Short side | p2 | | ΔT | Part of the |
|---|---|---|---|---|---|---|
| Configuration | [mm] | [mm] | [mm] | s/t | [° C.] | invention? |
| FIG. 9 | 30 | 30 | 420 | 2 | 12.297 | No |
| FIG. 10 | 105 | 105 | 420 | 1 | 16.636 | No |
| FIG. 11. | 30 | 83 | 210 | 1 | 13.386 | No |
| FIG. 12 | 30 | 120 | 420 | 2 | 15.507 | Yes |
| FIG. 13 | 30 | 124 | 420 | 1 | 16.588 | Yes |
| FIG. 14 | 30 | 72 | 420 | 1 | 14.255 | No |
| FIG. 15 | 30 | 72(124) | 420 | 1 | 14.167 | No |
| FIG. 16 | 30 | 124 | 420 | 1 | 16.261 | Yes |

The invention also relates to a window frame 200 comprising a plurality of elongated structures 20 in accordance with the above description. In particular, the elongated structures 20 are joined together so as to constitute the sides of a polygon, usually but not necessarily a rectangle. Preferably, the elongated structures 20 are arranged so that the respective first abutment surfaces 211, defined by each of the respective first crosspieces 21, lie on the same plane. In the same way, the elongated structures 20 are preferably arranged so that the respective second abutment surfaces 222, defined by the respective second crosspieces 22, lie on the same plane.

Finally, the invention relates to a window 219 comprising a window frame 200 in accordance with what is described above and a panel 19. The panel 19 extends mainly in the plane π parallel to the abutment surfaces 211 and 222. Preferably, the panel 19 is made in such a way as to have a low thermal conductivity. For example, the panel 19 can comprise an athermal glass and/or insulating glasses. Naturally, in order to satisfy specific requirements, the panel 19 can be made with different materials or techniques.

As the person skilled in the art may well understand, the fact that the second crosspiece 22 can be applied to the window frame 20 in a removable manner, for example by means of bolts 224, allows a high flexibility in fitting the window 219. In particular, it is possible to install the window frame 200, to conveniently apply the panel 19 and only then to apply the second crosspiece 22, by means of the bolts 224 being secured in a removable manner.

FIGS. 6 to 8 represent a particular solution according to the invention, in which at least one openable window frame 200 is arranged.

With particular reference to FIG. 6, on the right there is a fixed structure, on which a window frame 200 according to the invention is hinged. Specifically in FIG. 6, the fixed structure is in turn an elongated structure 20 according to the invention, but this is not at all necessary and the fixed structure could be a wall, a frame or any other element of the construction. A window frame 200 according to the invention is therefore mounted on the fixed structure by at least one hinge 40.

FIG. 7 shows the opposite end of the same openable window frame in FIG. 6. With particular reference to FIG. 7, on the left there is a fixed structure, on which a window frame 200 according to the invention abuts when it is closed. Also in FIG. 7, the fixed structure is an elongated structure 20 according to the invention, but as already stated above this is not necessary. The window frame 200 according to the invention comprises locking means 42, known per se, for locking it in the closed position on the fixed structure. The locking means 42 can for example be controlled by a handle and/or a key and can comprise a bolt, a lock, a latch or the like.

As can be seen in FIGS. 6 and 7, with the window frame 200 in the closed position, a chamber 44 is generated between the elongated structure 20 and the fixed structure. In order to generate such a chamber 44 it is possible to appropriately shape the cross-section of the fixed structure, or the cross-section of the elongated structure 20 of the openable window frame 200 or both cross-sections.

As already mentioned above with reference to FIG. 5.b, for the purposes of thermal insulation it is important that the openings 236 and 237 between the rods 230 of the elongated structure 20 are insulated from the surrounding environment. This need is particularly felt in the case of the openable window frame 200. For this reason, the elongated structure 20 of the openable window frame 200 comprises a seal 30 which laterally covers the openings 236 and 237. On the other side of the same elongated structure 20 the openings 236 and 237 are covered by the edge of the panel 19.

Preferably, the seal 30 arranged on the movable window frame also includes a lip 300 suitable for cooperating with a lip 302 arranged on a corresponding seal arranged on the fixed structure. The purpose, the structure and the operation of the lip 300 and of the lip 302 are known. Briefly, by bringing the window frame 200 to the closed position, at least one of the two lips is deformed and/or compressed so as to seal the closure and avoid leakage of air between inside and outside. The particularity of the lips shown in FIGS. 6 and 7 is that they are included in seals 30 also intended to cover laterally the openings 236 and 237 of the respective elongated structures 20.

As the skilled person can understand, the invention allows to overcome the drawbacks highlighted above with reference to the known art.

In particular, the present invention offers a window frame structure which has at the same time a reduced cross-section, excellent thermal insulation features and the mechanical features necessary to withstand the design loads.

Furthermore, the present invention makes available a window frame and a window made with the window frame structure having the above-described features.

It is clear that the specific features are described in relation to various embodiments of the invention with exemplifying and non-limiting intent. Obviously, a person skilled in the art may make further modifications and variations to this invention, in order to meet contingent and specific requirements. For example, the technical features described in connection with an embodiment of the invention may be extrapolated from it and applied to other embodiments of the invention. Such modifications and variations are, however, contained within the scope of the invention, as defined by the following claims.

1. Elongated structure for a window frame suitable for supporting a panel for separating an inner environment from an outer environment, wherein the elongated structure comprises:
a first crosspiece defining a first abutment surface;
a second crosspiece defining a second abutment surface, parallel to the first abutment surface;
a truss structure connecting the first crosspiece and the second crosspiece;
wherein the truss structure comprises rods extending from connection zones of the first crosspiece to connection zones of the second crosspiece; and wherein the rods are tapered.

2. Elongated structure according to claim 1, wherein the first abutment surface is spaced from the second abutment surface by a distance d, and wherein the distance d is comprised between 25 mm and 82 mm.

3. Elongated structure according to claim 1, wherein each rod comprises an outer edge, facing the first crosspiece, and an inner edge, facing the second crosspiece, and wherein in each rod, the shorter one among the outer edge and the inner edge is at least 100 mm long.

4. Elongated structure according to claim 1, wherein:
the connection zones of the first crosspiece are spaced the one from the other by a pitch p1;
the connection zones of the second crosspiece are spaced the one from the other by a pitch p2;
and wherein at least one among p1 and p2 is greater than 350 mm.

5. Elongated structure according to claim 1, wherein the truss structure has a thickness t and wherein each rod defines a minimum cross section having an extension s such that t≤s≤2t.

6. Elongated structure according to claim 1, wherein the first abutment surface defined by the first crosspiece and the second abutment surface defined by the second crosspiece develop parallelly to a plane π, and wherein the truss structure mainly extends in a plane τ, perpendicular to plane π.

7. Elongated structure according to claim 1, wherein the truss structure is part of a web which further comprises an inner rib and an outer rib.

8. Elongated structure according to claim 1, made of a metallic material.

9. Elongated structure according to claim 1, wherein in the truss structure, openings are comprised between the rods.

10. Elongated structure according to claims 5 and 6, wherein t is measured perpendicularly to plane τ and is comprised between 3 mm and 7 mm, preferably between 4 mm and 6 mm.

11. Elongated structure according to claim 1, wherein the second crosspiece is applied to the elongated structure in a removable manner.

12. Elongated structure according to claim 1, wherein the web further comprises a strut which protrudes from the outer rib toward the inner rib, or vice versa, remaining spaced by some tenth of millimeter from the rib toward which it protrudes.

13. Elongated structure according to claim 12, wherein the strut comprises and assembly hole.

14. Window frame comprising a plurality of elongated structures according to claim 1.

15. Window frame according to claim 14, wherein at least one elongated structure comprises a seal which laterally covers the openings so as to maintain still air inside them isolated from the outside.

16. Window comprising a window frame according to claim 14 and a panel which mainly extends in plane π.

17. Elongated structure according to claim 8, made of a metallic material selected in the group comprising stainless steel, iron, brass, bronze, aluminum and copper.

18. Elongated structure according to claim 11, wherein t is comprised between 4 mm and 6 mm.
